(19) United States
(12) Patent Application Publication
(10) Pub. No.: US 2006/0252886 A1
(43) Pub. Date: Nov. 9, 2006

(54) Enhanced paint adhesion polymer blends

(75) Inventor: Bill R. Bodiford, White Oak, TX (US)

Correspondence Address: Huntsman Corporation;Legal Department, 10003 Woodloch Forest Drive, The Woodlands, TX, 77380, US

(73) Assignee: Huntsman Polymers Corporation, Odessa (TX)

(21) Appl. No.: 10/555,373

(22) PCT Filed: Apr. 28, 2004
(86) PCT No.: PCT/US04/13038

§ 371 Date: Nov. 2, 2005

Related U.S. Application Data
(60) Provisional application No. 60/467,858, filed on May 5, 2003.

(51) Int. Cl. C08L 23/04

(52) U.S. Cl. 525/240

(57) ABSTRACT

According to embodiments of the present invention, a polymer blend having a high degree of paintability is disclosed having a base polymer component which may be propylene homopolymers or propylene copolymers, a polyolefin elastomer component present in any amount between about 5% and 20% by weight based upon the weight of the base polymer, wherein the polyolefin elastomer is made using a metallocene catalyst, and wherein the melt flow rate of the polyolefin elastomer is at least twice the value of the melt flow rate of the base polymer; and a hydroxy polyolefin component comprising a hydroxyl/terminated polyolefin having a weight average molecular weight of 1,000 to 5,000 and a hydroxyl value of any value in the range of between about 20 to 100 KOH mg/g.

### FIELD OF THE INVENTION

The present invention relates to blends comprising polypropylene polymers. More particularly it relates to blends of polymers which are paintable and have improved paint adhesion properties.

### DESCRIPTION OF THE RELATED ART

Polypropylene is recognized by chemists and polymer scientists as being a non-polar material. As such, the paintability of polypropylene is less than the surfaces of other materials which are more polar in nature, such as metals, woods, canvasses, etc. In order to render a polypropylene surface or article to have a greater affinity for an applied coating material, common methods in the art begin with the treatment of the article with an organic solvent to cleanse its surface. The cleansing step is followed by the application of an adhesion promoter prior to the application of the final coating material, which is often a paint or laquer. Other methods of pre-coating treatment include surface oxidation using a flame, or surface treatment with a corona discharge.

Due to environmental concerns, the use of organic solvents such as 1,1,1-trichloroethane in a pre-treatment step of polymers prior to their being painted is no longer a viable practical option. Current typical treatment includes the cleansing of the surface to be painted with isopropanol. However, because isopropanol is not as aggressive to the surface with respect to its action, the adhesion of paint later applied to surfaces treated with isopropanol do not exhibit levels of adhesion as high as when halogenated solvents were used. Additional methods include washing the surface with water or a water-based soap solution, but like isopropanol, aqueous treatments do not provide as high of levels of paint adhesion as the halogenated hydrocarbons did formerly.

### SUMMARY OF THE INVENTION

Embodiments of the present invention disclose a polymer blend having a high degree of paintability having a base polymer component which may be propylene homopolymers or propylene copolymers, a polyolefin elastomer component present in any amount between about 5% and 20% by weight based upon the weight of the base polymer, wherein the polyolefin elastomer is made using a metallocene catalyst, and wherein the melt flow rate of the polyolefin elastomer is at least twice the value of the melt flow rate of the base polymer; and a hydroxy polyolefin component comprising a hydroxyl-terminated polyolefin having a weight average molecular weight of 1,000 to 5,000 and a hydroxyl value of any value in the range of between about 20 to 100 KOH mg/g.

Other embodiments of the present invention disclose an article of manufacture comprising a thermoplastic article; a polymer blend which comprises, a base polymer component which may be propylene homopolymers or propylene copolymers; a polyolefin elastomer component present in any amount between about 5% and 20% by weight based upon the weight of the base polymer, wherein the polyolefin elastomer is made using a metallocene catalyst, and wherein the melt flow rate of the polyolefin elastomer is at least twice the value of the melt flow rate of the base polymer; and a hydroxy polyolefin component comprising a hydroxyl-terminated polyolefin having a weight average molecular weight of 1,000 to 5,000 and a hydroxyl value of any value in the range of between about 20 to 100 KOH mg/g; and at least one pigmented coating or paint.

Further embodiments of the present invention include a process to produce a polymer blend having a high degree of paintability by mixing a base polymer component, a polyolefin elastomer component and a hydroxyl polyolefin component; wherein the base polymer component is selected from the group consisting of: propylene homopolymers and propylene copolymers; wherein the polyolefin elastomer component is present in any amount between about 5% and 20% by weight based upon the weight of the base polymer, wherein the polyolefin elastomer component is made using a metallocene catalyst; wherein the melt flow rate of the polyolefin elastomer component is at least twice the value of the melt flow rate of the base polymer; wherein the hydroxy polyolefin component comprises a hydroxyl-terminated polyolefin having a weight average molecular weight of 1,000 to 5,000; and wherein the hydroxyl polyolefin component comprises a hydroxyl value of any value in the range of between about 20 to 100 KOH mg/g.

### DETAILED DESCRIPTION OF THE INVENTION

It is an object of the present invention to improve the paint adhesion of polypropylene homopolymer or polypropylene copolymer, or a blend thereof, using a substantially reduced amount of paint adhesion improving additives necessary to achieve satisfactory results with respect to formulations found in the prior art. By the present invention, one is enabled to provide materials having properties that more closely resemble the base polymer used, and in some cases reducing the amount of fillers needed to match the desired physical properties of the base polymer used. We have achieved formulations which, in the absence of any fillers, exhibit levels of paint adhesion as high as those levels in the prior art which were usually only attainable through the use of fillers.

According to prior art methods, it is not atypical for blenders to use relatively large percentages of rubber elastomers, on the order of from about 30-40% by weight based upon the weight of the base polymer used, to improve paint adhesion. The most common rubbers used for this purpose are EPDM and EPR.

By the inclusion of a metallocene-derived polyolefin elastomer (“POE”) in the blend alone or in combination with other rubbers, depending on the base polypropylene polymer combination used, paint adhesion can be improved. The use of rubbers having a much lower viscosity than the base polymer or rubbers that are more polar in nature than the base polymer typically aids paint adhesion properties at much lower levels than is typically used currently. Levels in the finished blend of as low as 5% POE elastomer and 2% polyhydroxy polyolefin are useful for significantly improving paint adhesion. Higher levels of these materials may be employed if additional paint adhesion is necessary or desired.

According to the present invention, a metallocene-derived elastomer is used in combination with a polyhydroxy polyolefin to improve the paint adhesion in a polypropylene homopolymer or copolymer blend. According to one preferred form of the invention, the polyhydroxy polyolefin has a low weight average molecular weight on the order of about 1000 to 5000; however, other polyhydroxy polyolefins are useful provided that the material has a sufficient hydroxyl value and the material is present on the surface of the item to be painted. Different POEs at the same addition level will provide better paint adhesion results if the POE has a much lower viscosity as compared to that of the base polymer. According to a preferred form of the invention, the melt index of the POE is about three times higher than that of the base polymer. Also using POEs which have a high content of a co-monomer (such as butene or octene) will provide improved results. According to one preferred form of the invention, the POE is a propylene-octene copolymer having an octene content in the range of from about 25% to about 40%.

A compositions according to the invention may be prepared by kneading the various components together; however; the preferred blending method utilizes a single or twin-screw extruder. The final product blend can be processed in many different ways such as blow molding; thermoforming, extrusion, or injection molding.

In embodiments of the present invention, an advantage is that less rubber may be needed in order to achieve paint adhesion than according to methods and compositions of the prior art. Further, making paintable materials according to embodiments of the present invention may result in less loss of some of the desirable physical properties, owing to reduced amounts of rubber present. In addition, desirable physical properties may be achieved using decreased levels of use of fillers to maintain stiffness. Finally, the final product blend according to the invention may possess a reduced weight due to lower filler content.

### The Base Polymer Component

Embodiments of the present invention is a multi-component blend, wherein one of the components is the base polymer, which may be present in the greatest amount on a per weight basis, based on the total weight of the blend, than any other single component in the blend. Many different base polymers may be utilized. Base polymers include, but are not limited to, polypropylene homopolymers, co-polymers of polypropylene with ethylene, butene, or octene as comonomers. One skilled in the art, with the benefit of this disclosure will recognize other suitable base polymers to be used in this invention.

Examples of preferred base polymers useful in accordance with the present invention are EXPR 12 and EXPR 14 having the physical properties listed below. The materials EXPR 12 and EXPR 14 (also known as AP6835) are available from Huntsman International LLC located in Marysville, Mich.

Huntsman EXPR 12

| | |
|---|---|
| Melt Flow Rate (ASTM D-1238) g/10 min. | 22.9 |
| EP rubber content (wt. %) | 23.43 |
| Total ethylene content (mol. %) | 18.3 |
| EP rubber intrinsic viscosity (dL/g) | 2.2 |
| Rockwell Hardness (R scale) | 81 |
| Heat deflection temperature (HDT)@ 66 psi | 75° C. |
| HDT@ 264 psi | 45° C. |
| Gardner Impact @ −30° C./(in/lbs) | 320 |
| INST. impact@ −30° C./15 mph J@maxload | 23.6 |
| INST. impact@ −18° C./15 mph (failure) | ductile |
| Tensile strength @ 50 mm/min | 2680 |
| Elongation @ yield (%) | 6 |
| Flexural modulus tan 5 (k psi) | 142 |
| Notched IZOD @ Tᵣₒₒₘ (ft-lbs/in.) | 11.64 |
| IZOD # −30° C. | 1.8 |

Huntsman EXPR 14

| | |
|---|---|
| Melt Flow Rate (ASTM D-1238) g/10 min. | 30 |
| EP rubber content (wt. %) | 20 |
| Total ethylene content (mol. %) | 13 |
| EP rubber intrinsic viscosity (dL/g) | 1.92 |
| Rockwell Hardness (R scale) | 93 |
| HDT@ 66 psi | 78 |
| HDT@ 264 psi | 49 |
| Gardner Impact @ −30° C./(in/lbs) | 320 |
| INST. impact@ −30° C./15 mph J@maxload | 26.6 |
| INST. impact@ −18° C./15 mph (failure) | ductile |
| Tensile strength @ 50 mm/min | 3130 |
| Elongation @ yield (%) | 6 |
| Flexural modulus tan 5 (k psi) | 158 |
| Notched IZOD @ Tᵣₒₒₘ (ft-lbs/in.) | 2 |
| IZOD # −30° C. | 1.7 |

### The Hydroxy Polyolefin Component

The hydroxy polyolefin component is a hydroxyl-terminated low-molecular-weight polyolefin having a molecular weight of 1,000 to 5,000. A suitable hydroxy polyolefin can be prepared by polymerizing a conjugated diene monomer according to the well-known technique of anionic polymerization, hydrolyzing the resulting product, and subsequently hydrogenating the polymer that results. A particularly preferred hydroxy polyolefin is one manufactured and sold by Mitsubishi Chemical Co. under the trade name of “POLYTAIL® H”. According to a preferred form of the invention, the hydroxy polyolefin component should preferably have a hydroxyl value (KOH mg/g) of any value in the range of between about 20 to 100. When the hydroxyl value is 20 or greater, the resulting resin composition typically provides good coating adhesion. However, if the hydroxyl value is greater than 100, the hydroxy polyolefin typically has poor compatibility with resins, resulting in low coating adhesion.

The Metallocene-derived Elastomer Component A blend according to the present invention includes a metallocene-derived elastomer, which may be a copolymer of polypropylene with at least one other monomer selected from the group consisting of: butene and octene, which metallocene-derived elastomer is made using a metallocene catalyst. It is preferable that when octene is used as a comonomer that the octene content is at least 20% by weight based upon the total weight of the elastomer used in the polymer blend, with any value between about 10% and 45% being useful. In those cases when butene is used as a comonomer, it is preferable that the butene content is at least 20% by weight based upon the total weight of the elastomer used in the polymer blend, with any value between about 10% and 45% being useful. According to a preferred form of the invention, the melt flow rate of the metallocene elastomer component is any melt flow rate in the range of between about 30 and 100 grams per 10 minutes using the method taught by ASTM D-1238.

Preferred metallocene-derived elastomers for use as components of a blend according to the invention include those commercially available from DuPont-Dow Elastomers, LLC under the tradenames ENGAGE® 8407 and ENGAGE® 8401. One skilled in the art, with the benefit of this invention will recognize other suitable metallocene-derived elastomers for use in this invention.

### EXAMPLES

One of the objects of the present invention is to provide a thermoplastic olefin (“TPO”) exhibiting a high degree of affinity for an applied paint coating. Several blends were produced for testing of the strength of adhesion of a conventional paint coating applied to the outer surface of a coupon of material made from the blends under consideration. The compositions of nine blends are set forth in table I below:

TABLE I
compositions of sample blends

| | Example Number | | | | | | | | |
|---|---|---|---|---|---|---|---|---|---|
| Materials | 1 | 2 | 3 | 4 | 5 | 6 | 7 | 8 | 9 |
| Huntsman EXPR 14 | — | — | — | — | — | 87.4 | 77.4 | 82.35 | 72.45 |
| Huntsman EXPR 12 | — | 100 | 97.75 | 86.0 | 76.0 | — | — | — | — |
| Huntsman P4G4Z-011 | — | — | — | — | — | — | 5 | — | 5 |
| ENGAGE ® 8407 | — | — | — | 10.0 | 20.0 | 10 | 15 | 15 | 10 |
| ENGAGE ®8401 | — | — | — | — | — | — | — | — | 10 |
| ESCORENE ® 8114 | 100 | — | — | — | — | — | — | — | — |
| POLYTAIL ®H | — | — | 2.0 | 4.0 | 4.0 | 2.5 | 2.5 | 2.5 | 2.5 |
| AMFINE ® NA-11 | — | — | — | — | — | 0.1 | 0.1 | 0.15 | 0.1 |
| ULTRANOX ®626 | — | — | 0.05 | 0.05 | 0.05 | — | — | — | — |
| IRGANOX ® 1010 | — | — | 0.10 | 0.10 | 0.10 | — | — | — | — |
| Ca stearate | — | — | 0.10 | 0.10 | 0.10 | — | — | — | — |
| Total | 100 | 100 | 100 | 100 | 100 | 100 | 100 | 100 | 100 |

In this specification and the appended claims, all parts and percentages specified are expressed on a weight basis unless stated otherwise. All melt flow rates were measured at 230 degrees centigrade as measured by ASTM D-1238. The blends of the examples may be made by blending the specified materials in a twin-screw extruder in a manner which is well known to those skilled in the art. For the testing of the adhesion of a coating to the various blends, plaques having dimensions 10 cm×15 cm×3 mm were made by injection molding. Coatings were subsequently applied to the various plaques. The first step in the application of the coating was to apply an adhesion promoter to the plaques. The promoter used was marketed by Rohm and Haas under name ACHP21054-4B1. The adhesion promoter was applied at a thickness in the range of 0.005-0.010 millimeters at room temperature, and was subjected to a delay of 5 minutes prior to application of the base coat. The base coat used was marketed by DuPont de Nemours under the name 872DF716 and was applied over the adhesion promoter layer at a thickness of 0.030 to 0.035 millimeters at room temperature, and was subjected to a delay of 3 minutes prior to the application of the clear coat. The clear coat used was marketed by DuPont de Nemours under the trade name RK3939 and was applied over the base coat layer at a thickness of 0.030 to 0.038 millimeters at room temperature, and was subjected to a delay of 10 minutes prior to a baking step. Subsequently, the plaques were baked in the baking step at 120 degrees Celsius for thirty minutes and allowed to cool to room temperature. The adhesion testing was not conducted until waiting at least 24 hours after the baking step was complete.

Determination of the strength of adhesion of the coating to the plaques was made by Technical Finishing, Inc. of Flint, Mich. The results of the adhesion testing for the nine Examples is set forth in table II below. It will be noticed that the data set for each material consists of five rows of data. The first five columns of the data for each set are adhesion test results. The sixth column is the average value of the five pull tests. The top row for each example represents the test results using a non-aggressive method. The remaining four rows for each example represent the test result using what is considered to be an aggressive testing method by Technical Finishing, Inc. The value in the column labeled “Gd Avg” (grade average) is the averaged value of all of the averages in the sixth column for each sample. The value in the column labeled “Tbr gate” is the Taber Abrasion test values obtained near the gate portion on the injection molded part, which Taber Abrasion test was run in accordance with General Motors test GM 9911P. The value in the column labeled “Tbr Agate” is the Taber Abrasion test values obtained as far away from the gate portion on the injection molded part as possible, which Taber Abrasion test was run in accordance with General Motors test GM 9911P.

TABLE II
adhesion test results

| | Pull 1 | Pull 2 | Pull 3 | Pull 4 | Pull 5 | Avg. | Gd Avg | Tbr gate | Tbr Agate |
|---|---|---|---|---|---|---|---|---|---|
| Example 1 | P | P | P | P | 1 | 0.2 | 1.4 | 83 | 82 |
| | 2 | 2 | 3 | 3 | 4 | 0.8 | | | |
| | P | P | P | 17 | 17 | 3.4 | | | |
| | P | P | P | P | 4 | 0.8 | | | |
| | P | 1 | 2 | 2 | 2 | 0.4 | | | |
| Example 2 | P | P | P | P | P | 0 | 19.8 | 0 | 0 |
| | 54 | — | — | — | — | 54 | | | |
| | 20 | 30 | 48 | — | — | 16 | | | |
| | 18 | 28 | 46 | — | — | 15.3 | | | |
| | 5 | 20 | 50 | — | — | 16.7 | | | |
| Example 3 | 3 | 3 | 5 | 13 | 21 | 4.2 | 9.8 | 0 | 0 |
| | 25 | 25 | 50 | — | — | 16.7 | | | |
| | 10 | 25 | 30 | 30 | 40 | 6 | | | |
| | P | 5 | 50 | — | — | 16.7 | | | |
| | P | 5 | 5 | 5 | 5 | 1 | | | |
| Example 4 | P | P | P | P | P | 0 | 2.2 | 56 | 36 |
| | P | P | P | P | P | 0 | | | |
| | P | 1 | 4 | 30 | 43 | 8.6 | | | |
| | P | P | P | P | P | 0 | | | |
| | P | P | P | P | P | 0 | | | |
| Example 5 | P | P | P | P | P | 0 | 0.1 | 76 | 14 |
| | P | 2 | P | P | P | 0.4 | | | |
| | P | P | P | P | P | 0 | | | |
| | P | P | P | P | P | 0 | | | |
| | P | P | P | P | P | 0 | | | |
| Example 6 | P | P | P | P | P | 0 | 0.2 | 53 | 16 |
| | P | P | P | 2 | 2 | 0.4 | | | |
| | P | P | P | 2 | 2 | 0.4 | | | |
| | P | P | P | P | P | 0 | | | |
| | P | P | P | P | P | 0 | | | |
| Example 7 | P | P | P | P | P | 0 | 0.2 | 12 | 22 |
| | P | P | P | 4 | 4 | 0.8 | | | |
| | P | P | P | P | P | 0 | | | |
| | P | P | P | P | P | 0 | | | |
| | P | P | P | P | P | 0 | | | |
| Example 8 | P | P | P | P | P | 0 | 0.2 | 9 | 16 |
| | P | P | P | P | P | 0 | | | |
| | P | P | 3 | 3 | 3 | 0.6 | | | |
| | P | P | P | P | P | 0 | | | |
| | P | P | 2 | 2 | 2 | 0.4 | | | |
| Example 9 | P | P | P | P | P | 0 | 0.1 | 39 | 34 |
| | P | P | P | P | P | 0 | | | |
| | P | P | P | P | P | 0 | | | |
| | P | P | P | P | 1 | 0.2 | | | |
| | P | P | P | P | P | 0 | | | |

The material of Example 1, ESCORENE® 8114 (a.k.a. “PP8114”) is a material of popular choice for manufacturers of bumpers and fascia in the automotive industry and commercially available from ExxonMobil Chemicals of Baytown, Tex. Example 2 depicts a typical polymer having no paint adhesion enhancement additives. It is evident that addition of a standard additive package and a hydroxy polyolefin that is believed by those skilled in the art as being useful for increasing paint adhesion does not have a dramatic effect on paint adhesion, when the adhesion results of Example 3 are compared to Example 2. The grade average of Example 4 is nearly as good as the grade average of Example 1. Thus, it appears as though the addition of the ENGAGE® 8407 metallocene elastomer (commercially available from Dow Chemical Company of Midland, Mich.) has had a dramatic effect on the paint adhesion test results. Further increase of the percentage of the metallocene elastomer content in Example 5 yields a material whose grade average for adhesion testing is better than that of Example 1, which is considered to be the control material. Although it might be argued that the level of POLYTAIL®H present in Examples 4 and 5 is double of that of Example 3 and it might thus be that the favorable increase in the paint adhesion results in part at least from the increased level of the POLYTAIL®H, Examples 6, 7, 8, and 9 all have levels of POLYTAIL®H which are about the same as in Example 3, yet the paint adhesion tests differ dramatically between those of Example 3 and Examples 6, 7, 8, and 9. Examples 6, 7, 8, and 9 all exemplify the invention. Each of these samples show better paintability than the control material EXXON® 8114. What is remarkable about this result is that according to the teachings of the prior art, blenders must utilize upwards of 30% of rubber elastomers such as: ethylene propylene diene moonomer rubber, EP rubber, polymers sold under the ENGAGE® trademark by Dow Chemical, polymers sold under the NORDEL® trademark by Dow Chemical, and polymers sold under the EXACT® trademark by ExxonMobil, to achieve the same degree of paint adhesion. Since the cost of rubber elastomers is relatively high and since using high levels of rubber elastomers tends to influence the physical properties of the blend in proportion to the percentage of rubber elastomer used, by the teachings of the present invention it is possible to keep the cost of the blend to a minimum by reducing the amount of rubber elastomer required for sufficient paint adhesion, while simultaneously preserving the physical properties of the finished blend.

TABLE 3
Properties of preferred embodiments

| | EXRP14 | Example 6 | Example 7 | Example 8 | Example 9 |
|---|---|---|---|---|---|
| ISO TESTING | | | | | |
| Melt flow ASTM D-1238 | 30 | 31.6 | 28.8 | 31.7 | 29.1 |
| Tensile | | | | | |
| at yield | 21 | 19.3 | 18.9 | 18.2 | 17.8 |
| Elongation % at Yield | 6 | 9.8 | 10.4 | 9.29 | 12.9 |
| Flex Modulus | | | | | |
| chord | 970 | 945 (137) | 910 (132) | 890 (129) | 845 (123) |
| tangent | 1025 | 1000 (145) | 959 (139) | 955 (138) | 897 (131) |
| secant | 950 | 922 (134) | 895 (130) | 876 (127) | 835 (121) |
| Notched IZOD 23° | | | | | |
| A notch | 9.48 | 40 | 40 | 42 | 41 |
| Type of Break | CB | NB | NB | NB | NB |
| B notch | 20 | 45 | 47 | 49 | 48 |
| Type of Break | CB | N B | NB | NB | NB |
| Notched IZOD −30° C. | | | | | |
| A notch kJ/m² | 5.2 | 6.2 | 6.06 | 7.3 | 6.48 |
| type of break | CB | CB | CB | CB | CB |
| B notch | 9.7 | 16.4 | 17.4 | 20 | 17.3 |
| type of break | CB | CB | CB | CB | CB |
| peak dynatup −30° C., | 18 | 25.23 | 24.89 | 23.94 | 23.73 |
| 2.2 m/sec. | | | | | |
| Failure type | 1B 9D | D | D | D | D |

One advantage of a blend according to the invention is that the physical properties of the base polymer are not as significantly effected by being blended with the other blend components as are other blends in the prior art which are aimed at the same uses as the present invention. It is typical in the prior art for the melt flow rate (MFR) of the base polymer utilized to begin with a MFR of about 35 g/10 min and be decreased to about 20 g/10 minutes as a result of being blended in accordance with the prior art. The blends of the present invention do not suffer such a disadvantage as evidenced in the table above in which the MFR's of the final blends does not vary but slightly from that of the base polymer.

Another advantage of the present invention is that unlike the prior art, the present invention does not rely upon the use of fillers, such as talc and other fillers known in the art, to improve paint adhesion. One skilled in the art, with the benefit of this disclosure will recognize appropriate fillers suitable for use in the present invention.

According to one embodiment of the present invention, the melt flow rate of the polyolefin elastomer component is at least two times the value of the base polymer, as measured using ASTM D-1238.

According to one embodiment of the present invention, the melt flow rate of the base polymer is less than 30, as measured using ASTM D-1238.

According to one embodiment of the present invention, the polyolefin elastomer component is present in an amount of between about 5% and 20% by weight based upon the total weight of a polymer blend according to the invention.

According to one embodiment of the present invention, the polyolefin elastomer component is present in an amount of between about 5% and 15% by weight based upon the total weight of a polymer blend according to the invention.

The blends of the present invention thus are thermoplastic polyolefins which are paintable. As such, they are suitable for many uses, including automotive end uses, such as for preparing, such as by molding or other processes known to those skilled in the art, automotive bumpers, automotive interior trim components, automotive exterior trim components, general articles of manufacture such as lawn furniture, rain gutters, trim for homes and offices, etc. The present invention thus provides thermoplastic articles of manufacture which comprise the polymer blends of the invention having an outer surface, which further comprises a pigmented coating or paint disposed on its outer surface. Such surfaces may be painted using pigmented coatings wherein the color of the paint is red, yellow, black, white, red, green, brown, and silver, or any other color.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the foregoing and other contents of this specification.

What is claimed is:

1)-14) (canceled)

15) A polymer blend having a high degree of paintability comprising:
a) a base polymer component which is selected from the group consisting of: propylene homopolymers and propylene copolymers;
b) a polyolefin elastomer component present in any amount between about 5% and 20% by weight based upon the weight of the base polymer, wherein the polyolefin elastomer is made using a metallocene catalyst, and wherein the melt flow rate of the polyolefin elastomer is at least twice the value of the melt flow rate of the base polymer; and
c) a hydroxy polyolefin component comprising a hydroxyl-terminated polyolefin having a weight average molecular weight of 1,000 to 5,000 and a hydroxyl value of any value in the range of between about 20 to 100 KOH mg/g.

16) A polymer blend according to claim 15 further comprising talc in any amount between 0.001% and 25.00% by weight.

17) A polymer blend according to claim 15 wherein the polyolefin elastomer component present in any amount between about 5% and 15% by weight based upon the weight of the base polymer.

18) A polymer blend according to claim 15 wherein the melt flow rate of the polymer blend is higher than the melt flow rate of that of the base polymer.

19) A polymer blend according to claim 15 wherein the hydroxy polyolefin component comprises at least 2% by weight of the polymer blend.

20) A polymer blend according to claim 15 wherein the polyolefin elastomer component comprises a co-monomer.

21) A polymer blend according to claim 20 wherein the co-monomer comprises butene or octene.

22) A polymer blend according to claim 15 wherein the polyolefin elastomer component comprises a propylene-octene copolymer.

23) A polymer blend according to claim 22 wherein the propylene-octene copolymer has an octene content in the range of from about 10% to about 45% by weight of the polymer blend.

24) A polymer blend according to claim 22 wherein the propylene-octene copolymer has an octene content of at least 20% by weight of the polymer blend.

25) A polymer blend according to claim 15 wherein the polyolefin elastomer component comprises a propylene-butene copolymer.

26) A polymer blend according to claim 25 wherein the propylene-butene copolymer comprises in the range from about 10% to about 45% by weight of the polymer blend.

27) A polymer blend according to claim 25 wherein the propylene-butene copolymer comprises at least 20% butene by weight of the polymer blend.

28) A blend according to claim 15 wherein the base polymer has a melt flow rate of between about 30 and 100 grams per 10 minutes.

29) A blend according to claim 15 wherein the melt flow rate of the polyolefin elastomer is at least three times the value of the melt flow rate of the base polymer

30) An article of manufacture comprising:
a thermoplastic article;
a polymer blend which comprises,
a) a base polymer component which is selected from the group consisting of: propylene homopolymers and propylene copolymers;
b) a polyolefin elastomer component present in any amount between about 5% and 20% by weight based upon the weight of the base polymer, wherein the polyolefin elastomer is made using a metallocene catalyst, and wherein the melt flow rate of the polyolefin elastomer is at least twice the value of the melt flow rate of the base polymer; and
c) a hydroxy polyolefin component comprising a hydroxyl-terminated polyolefin having a weight average molecular weight of 1,000 to 5,000 and a hydroxyl value of any value in the range of between about 20 to 100 KOH mg/g; and
(d) at least one pigmented coating or paint.

31) An article of claim 30, wherein the thermoplastic article comprises an automotive product.

32) An article of claim 31, wherein the automotive product comprises a bumper, an interior trim component, or an exterior trim component.

33) A process to produce a polymer blend having a high degree of paintability comprising:
mixing a base polymer component, a polyolefin elastomer component and a hydroxyl polyolefin component;
wherein the base polymer component is selected from the group consisting of: propylene homopolymers and propylene copolymers;
wherein the polyolefin elastomer component is present in any amount between about 5% and 20% by weight based upon the weight of the base polymer, wherein the polyolefin elastomer component is made using a metallocene catalyst;
wherein the melt flow rate of the polyolefin elastomer component is at least twice the value of the melt flow rate of the base polymer;
wherein the hydroxy polyolefin component comprises a hydroxyl-terminated polyolefin having a weight average molecular weight of 1,000 to 5,000; and
wherein the hydroxyl polyolefin component comprises a hydroxyl value of any value in the range of between about 20 to 100 KOH mg/g.

34) A process of claim 33 further comprising adding a filler.
